(19) United States
(12) Patent Application Publication
(10) Pub. No.: US 2025/0240612 A1
(43) Pub. Date: Jul. 24, 2025

(54) DIFFERENTIAL LOCATION ACCURACY

(71) Applicant: Cisco Technology, Inc., San Jose, CA (US)

(72) Inventors: Jerome HENRY, Pittsboro, NC (US); Matthew A. SILVERMAN, Shaker Heights, OH (US); Robert E. BARTON, Richmond (CA); Robert C. BADEA, Broadview Heights, OH (US)

(21) Appl. No.: 18/421,923

(22) Filed: Jan. 24, 2024

(51) Int. Cl. H04W 8/08; H04W 12/0431

(52) U.S. Cl. CPC H04W 8/08; H04W 12/0431

(57) ABSTRACT

The present disclosure describes a system that provides different levels of location accuracy to different types of devices using different types of location technologies (e.g., RSSI, FTM, UWB, Bluetooth). An access point includes a memory and a processor communicatively coupled to the memory. The processor provides a location determination for a client device according to a first accuracy level and in response to receiving, from the client device, a request for a second accuracy level of location determination greater than the first accuracy level, determines a location device that provides the second accuracy level. The processor also communicates, to the client device, a report indicating a neighboring access point and the location device.

### TECHNICAL FIELD

Embodiments presented in this disclosure generally relate to wireless communication. More specifically, embodiments disclosed herein relate to a system for using different types of location technologies to provide different levels of location accuracy to different types of devices.

### BACKGROUND

Different types of devices may use a network (e.g., a wireless fidelity (WiFi) network) to determine their locations. These location determinations may provide a certain level of accuracy. Some types of devices need or benefit from location determination with greater levels of accuracy than existing networks can provide.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system.

FIG. 2 illustrates an example location device in the system of FIG. 1.

FIG. 3 illustrates an example access point or location device in the system of FIG. 1.

FIG. 4 illustrates an example operation performed by the system of FIG. 1.

FIG. 5 illustrates an example operation performed by the system of FIG. 1.

FIG. 6 illustrates an example operation performed by the system of FIG. 1.

FIG. 7 is a flowchart of an example method performed by the system of FIG. 1.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a system that provides different levels of location accuracy to different types of devices using different types of location technologies (e.g., received signal strength indicators (RSSIs), fine timing measurement (FTM), ultra-wideband (UWB), Bluetooth). According to an embodiment, an access point includes a memory and a processor communicatively coupled to the memory. The processor provides a location determination for a client device according to a first accuracy level and in response to receiving, from the client device, a request for a second accuracy level of location determination greater than the first accuracy level, determines a location device that provides the second accuracy level. The processor also communicates, to the client device, a report indicating a neighboring access point and the location device.

According to another embodiment, a method includes providing, by an access point, a location determination for a client device according to a first accuracy level, in response to receiving, from the client device, a request for a second accuracy level of location determination greater than the first accuracy level, determining a location device that provides the second accuracy level, and communicating, to the client device, a report indicating a neighboring access point and the location device.

According to another embodiment, a non-transitory computer readable medium stores instructions that, when executed by a processor, cause the processor to perform a fine timing exchange with a client device to determine a location of the client device according to a first accuracy level and in response to receiving, from the client device, a request for a second accuracy level greater than the first accuracy level, determine a location device that provides the second accuracy level. The location device includes a neighboring access point and an ultra-wideband anchor. The processor also communicates, to the client device, an 802.11k neighbor report that indicates (i) an address of the neighboring access point and (ii) an address of the location device.

### Example Embodiments

Devices may use different types of location technologies to determine the devices' locations. For example, devices may use RSSI, FTM, UWB, Bluetooth, etc. to determine the devices' locations. Each location technology allows the devices to determine location to different levels of accuracy. Existing WiFi networks typically use RSSI and FTM to determine the locations of devices in the networks. Some types of devices (e.g., automated guided vehicles (AGVs)), however, need or benefit from even more accurate location determinations.

The present disclosure describes an access point that instructs certain devices on the network how to obtain more accurate location determinations. Generally, when a device on the network (e.g., a client device) requests location determination with additional accuracy, the access point may include in a report (e.g., an 802.11k report) indications of other location technologies near the access point that the device can use to determine location with additional accuracy. For example, the report may indicate the address or location of a location device (e.g., another access point with a connected or co-located UWB anchor) neighboring the access point. The device may use the information in the report to request and receive a distance determination using the location device, which provides additional accuracy relative to the access point.

In certain embodiments, the access point provides certain technical advantages. For example, the access point may provide a client device access to location determinations with improved accuracy according to the needs of the client device. As another example, the access point may provide access to more accurate location determinations without necessarily providing those location determinations itself.

FIG. 1 illustrates an example system 100. As seen in FIG. 1, the system 100 includes one or more access points 102, a location device 104, and one or more devices 106. Generally, the devices 106 connect to an access points 102. The access point 102 provides network coverage for the system 100. The access point 102 communicates messages to the devices 106 and directs messages from the devices 106 towards their destination.

The access point 102 facilitates wireless communication (e.g., WiFi communication) in the system 100. One or more devices 106 may connect to the access point 102. The access point 102 may then facilitate wireless communication for the connected devices 106. For example, the access point 102 may transmit messages to a connected device 106. As another example, the access point 102 may receive messages transmitted by the device 106. The access point 102 may then direct that message towards its intended destination.

The access point 102 may also use certain procedures or techniques to determine the location of a device 106 in the system 100. For example, the access point 102 may determine the directionality of received messages from the device 106 to determine the direction in which the device 106 is positioned relative to the access point 102. The access point 102 may determine RSSI values for the device 106 and use those RSSI values to estimate the distance between the access point 102 and the device 106. The access point 102 may use FTM exchanges with the device 106 to estimate the distance between the access point 102 and the device 106. These procedures or techniques may allow the access point 102 and/or the device 106 to determine the location of the device 106, but the accuracy of these determined locations is limited.

The location device 104 may allow the access point 102 and/or the device 106 to determine the location of the device 106 with increased accuracy. For example, the location device 104 may include an access point 102 and another communication technology (e.g., a UWB anchor, a Bluetooth device, etc.). The location device 104 may use these other communication technologies to provide a location determination with increased accuracy. The device 106, however, may not know about the location device 104 when the device 106 is connected to the access point 102.

Generally, the access point 102 may inform the device 106 about the location device 104 when the device 106 indicates that improved accuracy for the location determination is needed. For example, the device 106 may communicate, to the access point 102, a request for improved accuracy. In response, the access point 102 may communicate a report (e.g., an 802.11k report) to the device 106 that indicates an address (e.g., internet protocol (IP) address, media access control (MAC) address) and/or a location of the location device 104, which may provide the device 106 the improved accuracy that the device 106 requested. The device 106 may then connect to the location device 104 and/or perform a location determination procedure (e.g., using UWB or Bluetooth) with the location device 104. In this manner, the access point 102 provides the device 106 a way to receive enhanced location services (e.g., determined locations with improved accuracy).

In some embodiments, the access point 102 determines whether the device 106 should receive enhanced location services from the location device 104. For example, when the device 106 connects to the access point 102, the access point 102 may determine a device type for the device 106. Some types of devices (e.g., phones, laptops, etc.) do not require enhanced location services, but some types of devices (e.g., AGVs in industrial settings) do require enhanced location services. If the access point 102 determines, from the device type, that the device 106 requires enhanced location services, the access point 102 may then include, in the report to the device 106, the address and/or location of the location device 104. The device 106 may then connect to the location device 104 and/or receive enhanced location services from the location device 104.

In particular embodiments, the access point 102 communicates a key to the device 106 if the access point 102 determines that the device 106 requires enhanced location services. The access point 102 may include, in the report to every device 106, the address and/or location of the location device 104, but the access point 102 may encrypt the address and/or location of the location device 104 in the report. Only devices 106 that have the key may use the key to decrypt the address and/or location of the location device 104. In this manner, the access point 102 controls which devices 106 may access the address and/or location of the location device 104.

In some embodiments, instead of or in addition to encrypting the address and/or location of the location device 104 in the report, the access point 102 and/or the location device 104 encrypts the enhanced location services information to the device 106. For example, the messages from the access point 102 and/or the location device 104 may include information from lower accuracy location determination procedures (e.g., RSSI or FTM procedures) and information from enhanced location services (e.g., UWB or Bluetooth procedures). The access point 102 and/or the location device may encrypt the information from enhanced location services (similar to how the access point 102 encrypts the address and/or location of the location device 104 in the previous example). In this manner, the information from lower accuracy location determination procedures may be made available to every device 106, but only devices 106 with the key may decrypt the information from enhanced location services. In this manner, the access point 102 and/or the location device 104 control which devices 106 may access the information from enhanced location services.

The device 106 may be any suitable device that wirelessly connects to the access point 102. As an example and not by way of limitation, the device 106 may be a computer, a laptop, a wireless or cellular telephone, an electronic notebook, a personal digital assistant, a tablet, an AGV, or any other device capable of receiving, processing, storing, or communicating information with other components of the system 100. The device 106 may be a wearable device such as a virtual reality or augmented reality headset, a smart watch, or smart glasses. The device 106 may also include a user interface, such as a display, a microphone, keypad, or other appropriate terminal equipment usable by the user. The device 106 may include a hardware processor, memory, or circuitry configured to perform any of the functions or actions of the device 106 described herein. For example, a software application designed using software code may be stored in the memory and executed by the processor to perform the functions of the device 106.

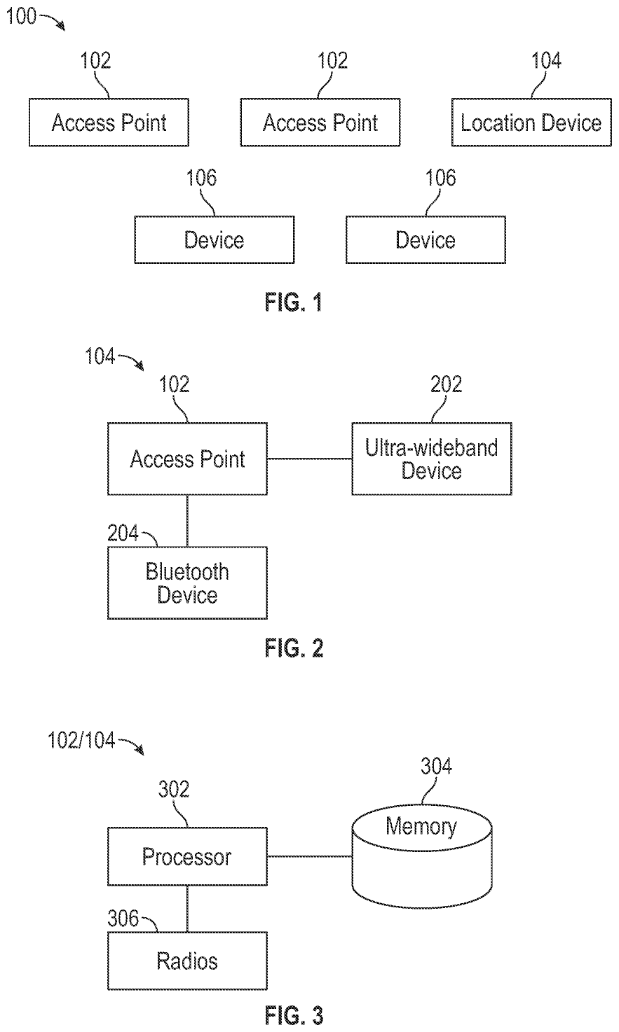

FIG. 2 illustrates an example location device 104 in the system 100 of FIG. 1. As seen in FIG. 2, the location device 104 includes multiple devices that use different communication technologies. For example, the location device 104 may include an access point 102, a UWB device 202, and a Bluetooth device 204. Each of these devices may implement or perform different location determination procedures. For example, the access point 102 may determine the location of devices 106 in the system 100 using RSSI and/or FTM exchanges. The UWB device 202 may determine the locations of devices 106 using short-range radio waves emitted from UWB anchors positioned in the system 100. The Bluetooth device 204 may determine the locations of devices 106 using radio waves emitted from Bluetooth low energy (BLE) beacons positioned in the system. The location device 104 may use multiple of these devices to determine the locations of devices or to improve the accuracy of location determinations.

FIG. 3 illustrates an example access point 102 or location device 104 in the system 100 of FIG. 1. As seen in FIG. 3, the access point 102 or location device 104 includes a processor 302, a memory 304, and one or more radios 306.

The processor 302 is any electronic circuitry, including, but not limited to one or a combination of microprocessors, microcontrollers, application specific integrated circuits (ASIC), application specific instruction set processor (ASIP), and/or state machines, that communicatively couples to the memory 304 and controls the operation of the access point 102 and/or location device 104. The processor 302 may be 8-bit, 16-bit, 32-bit, 64-bit or of any other suitable architecture. The processor 302 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 302 may include other hardware that operates software to control and process information. The processor 302 executes software stored on the memory 304 to perform any of the functions described herein. The processor 302 controls the operation and administration of the access point 102 and/or location device 104 by processing information (e.g., information received from the devices 106, memory 304, and radios 306). The processor 302 is not limited to a single processing device and may encompass multiple processing devices contained in the same device or computer or distributed across multiple devices or computers. The processor 302 is considered to perform a set of functions or actions if the multiple processing devices collectively perform the set of functions or actions, even if different processing devices perform different functions or actions in the set.

The memory 304 may store, either permanently or temporarily, data, operational software, or other information for the processor 302. The memory 304 may include any one or a combination of volatile or non-volatile local or remote devices suitable for storing information. For example, the memory 304 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 304, a disk, a CD, or a flash drive. In particular embodiments, the software may include an application executable by the processor 302 to perform one or more of the functions described herein. The memory 304 is not limited to a single memory and may encompass multiple memories contained in the same device or computer or distributed across multiple devices or computers. The memory 304 is considered to store a set of data, operational software, or information if the multiple memories collectively store the set of data, operational software, or information, even if different memories store different portions of the data, operational software, or information in the set.

The radios 306 may communicate messages or information using different communication technologies. For example, access point 102 and/or location device 104 may use one or more of the radios 306 for WiFi communications. The location device 104 may use one or more of the radios 306 for UWB or BLE communications. The access point 102 and/or location device 104 may include any number of radios 306 to communicate with any number of devices 106 using any number of communication technologies.

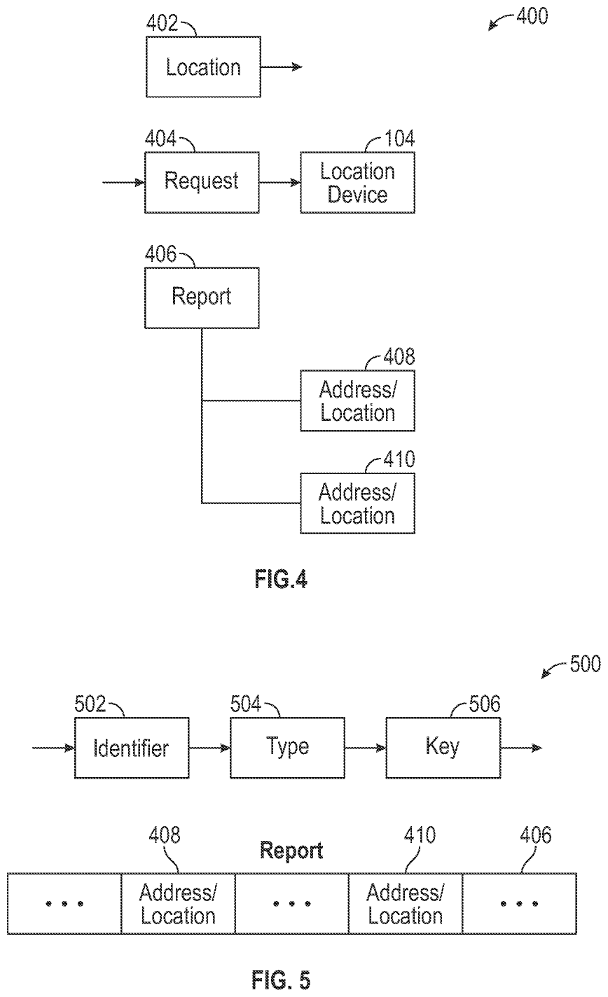

FIG. 4 illustrates an example operation 400 performed by the system 100 of FIG. 1. In particular embodiments, the access point 102 performs the operation 400. By performing the operation 400, the access point 102 informs a device 106 of how to receive more accurate location determinations using the location device 104.

The access point 102 determines a location 402 of the device 106 and communicates the location 402 to the device 106. The access point 102 may use RSSI or FTM exchanges with the device 106 to determine the location 402 of the device 106 in the system 100. The location 402, however, may not have the accuracy desired by the device 106. For example, the device 106 may be an AGV navigating in an industrial environment. RSSI and FTM exchanges may not provide the AGV with a location 402 with sufficient accuracy for the AGV to safely navigate through the environment.

The device 106 communicates a request 404 to the access point 102. The request 404 may indicate a desire or need for a location determination with improved or enhanced accuracy. The access point 102 receives the request 404 and determines that the location device 104 may provide the desired location determination with improved accuracy. The access point 102 may determine the address and/or location of the location device 104.

The access point 102 then generates a report 406, which may be an 802.11k report. The report 406 may include the addresses and/or locations of access points 102 in the system 100. In the example of FIG. 4, the report 406 includes the address and/or location 408 of another access point (e.g., an access point that neighbors the access point 102) in the system. The report 406 also includes the address (e.g., an IP address or MAC address) and/or location 410 of the location device 104 in the system 100. The access point 102 then communicates the report 406 to the device 106 in response to the request 404. When the device 106 receives the report 406, the device 106 may retrieve the address and/or location 410 of the location device 104 from the report 406. The device 106 may understand that the inclusion of the address and/or location 410 in the report 406 is a signal from the access point 102 that the location device 104 can determine the location of the device 106 with the requested or desired accuracy. The device 106 may then connect to the location device 104 so that the location device 104 can assist in determining the location of the device 106.

FIG. 5 illustrates an example operation 500 performed by the system 100 of FIG. 1. The access point 102 may perform the operation 500. By performing the operation 500, the access point 102 encrypts the information about the location device 104 in the report 406 so that the report 406 may be broadcast to multiple devices 106 in the system 100. As a result, the access point 102 does not need to wait for a request from a device 106 for improved accuracy before supplying the information about the location device 104.

The access point 102 receives an identifier 502 from a device 106 attempting to connect to the access point 102. The device 106 may communicate the identifier 502 to the access point 102 when the device 106 is attempting to associate with the access point 102. The identifier 502 may indicate a type 504 of the device 106. For example, the identifier 502 may indicate that the device 106 is an AGV, phone, laptop, etc. The access point 102 may determine, from the type 504, what level of location accuracy is needed by the device 106. For example, if the device 106 is a phone or laptop, the access point 102 may determine that RSSI or FTM exchanges provided by the access point 102 provide a sufficient level of accuracy for the device 106. If the device 106 is an AGV, the access point 102 may determine that the device 106 needs increased accuracy than what the access point 102 can provide.

If the access point 102 determines, from the type 504, that the device 106 needs increased accuracy than what the access point 102 can provide, the access point 102 generates and/or communicates a key 506 to the device 106. The device 106 may use the key 506 to decrypt information about and/or from the location device 104 in subsequent communications. If the access point 102 determines, from the type 504, that the access point 102 provides sufficient accuracy for the device 106, then the access point 102 may refrain from communicating the key 506 to the device 106.

As seen in FIG. 5, the access point 102 includes the address and/or location 408 of another access point 108 in the report 406. The access point 102 also includes the address and/or location 410 of the location device 104 in the report 406. The access point 102 may encrypt the address and/or location 410 in the report 406. As a result, when the access point 102 broadcasts the report 406 to multiple devices 106 in the system 100, only the devices 106 that have the key 506 may decrypt the address and/or location 410. Devices 106 that do not have the key 506 may be limited to the address and/or location 408. Devices 106 that have the key 506 may access the address and/or location 408 and the address and/or location 410. As a result, the access point 102 may broadcast the report 406 to every device 106 in the system 100, and the devices 106 that need increased accuracy may use the key 506 to access the address and/or location 410 of the location device 104 from the report 406 while the devices 106 that do not need increased accuracy may be limited to the address and/or location 408 in the report 406.

The system 100 may support multiple tiers or levels of accuracy for location determination. Each tier or level may use a different key 506. The access point 102 may determine, from the type 504 of a device 106, what tier or level of accuracy the device 106 needs. The access point 102 may then provide the device 106 the key 506 for that tier or level of accuracy. In the report 406, the access point 102 may include the addresses and/or locations of different devices in the system 100 that can provide the different tiers or levels of accuracy. The address and/or location for a device may be encrypted using a key for the particular tier or level of accuracy provided by the device. The access point 102 may broadcast the report 406 to every device 106 in the system 100, and the devices 106 may use their respective keys to access the address and/or location for their desired level of accuracy.

In some embodiments, the location device 104 also uses the same encryption when performing a location determination procedure with the device 106. The location device 104 may also encrypt the determined location information for the device 106. The device 106 may use the key 506 to perform decryption during the location determination procedure and to decrypt the determined location from the location device 104.

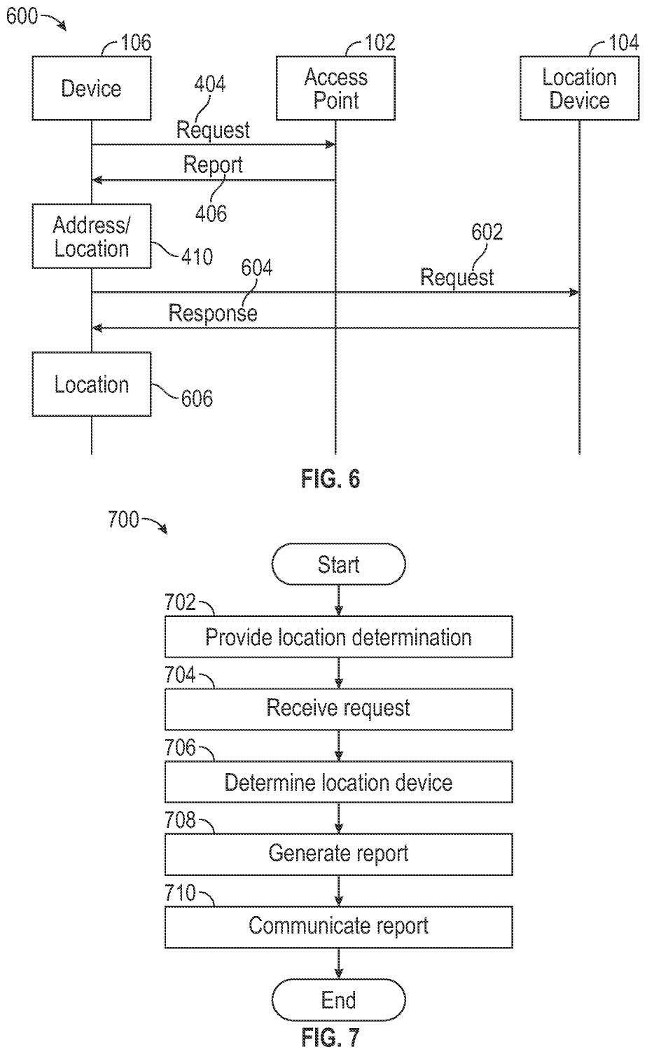

FIG. 6 illustrates an example operation 600 performed by the system 100 of FIG. 1. As seen in FIG. 6, the device 106 begins by communicating the request 404 to the access point 102. The device 106 may communicate the request 404 to indicate to the access point 102 that the device 106 needs an increased level of accuracy for location determination. In some embodiments, the access point 102 may determine that the device 106 needs the increased level of accuracy by determining the type for the device 106 when the device 106 associates with or connects to the access point 102.

The access point 102 communicates the report 406 to the device 106. In some instances, the access point 102 communicate the report 406 to the device 106 in response to the request 404. In certain instances, the access point 102 communicates the report 406 to the device 106 by broadcasting the report 406 throughout the system 100. The report 406 may include the address and/or location 410 of the location device 104, which may provide the increased level of accuracy for the device 106. The device 106 may retrieve the address and/or location 410 from the report 406. In some embodiments, the device 106 retrieves the address and/or location 410 from the report 406 by using the key 506 provided by the access point 102 to decrypt the address and/or location 410 in the report 406.

The device 106 then communicates a request 602 to the location device 104 according to the address and/or location 410 from the report 406. The request 602 may request the location device 104 to determine the location of the device 106 with the increased level of accuracy. The location device 104 may then determine the location 606 of the device 106 (e.g., using UWB and/or BLE) and communicate a response 604 to the device 106. The response 604 may indicate the determined location 606 of the device 106. The device 106 may retrieve the location 606 from the response 604. The location 606 may have increased accuracy relative to the accuracy that the access point 102 can provide the device 106.

FIG. 7 is a flowchart of an example method 700 performed by the system 100 of FIG. 1. In particular embodiments, the access point 102 performs the method 700. By performing the method 700, the access point 102 directs a device 106 to the location device 104, which can provide location determination with improved accuracy relative to the access point 102.

In block 702, the access point 102 provides a location determination to the device 106. For example, the access point 102 may use RSSI values or FTM exchanges to determine the location of the device 106. The determined location, however, may not have the level of accuracy that the device 106 needs to operate. In block 704, the access point 102 receives the request 404 from the device 106. The request 404 may be for an increased level of accuracy in location determination. In response to the request 404, the access point 102 determines that the location device 104 can provide the increased level of accuracy in block 706.

The access point 102 generates the report 406 in block 708. The report 406 may be an 802.11k report that includes the addresses and/or location of other access points 102 in the system 100. The access point 102 may also include in the report 406 the address and/or location 410 of the location device 104 to signal to the device 106 that the location device 104 can provide the increased level of accuracy requested by the device 106. The access point 102 then communicates the report 406 to the device 106 in block 710. The device 106 may retrieve the address and/or location 410 of the location device 104 from the report 406 to determine how to communicate with the location device 104 to receive the location determination with the improved level of accuracy.

In some embodiments, the access point 102 and/or the location device 104 may introduce some inaccuracy into the determined location for the device 106. The small level of inaccuracy may allow the device 106 to operate more safely. For example, if the device 106 is an AGV, adding some inaccuracy to the determined location may cause the AGV to take slightly different paths while navigating through an environment, which may reduce wear on the floor or ground.

In summary, the access point 102 instructs certain devices 106 on the network how to obtain more accurate location determinations. Generally, when a device 106 on the network requests location determination with additional accuracy, the access point 102 may include in a report 406 (e.g., an 802.11k report) indications of other location technologies near the access point 102 that the device 106 can use to determine location with additional accuracy. For example, the report 406 may indicate the address or location 410 of a location device 104 (e.g., another access point with a connected or co-located UWB anchor) neighboring the access point 102. The device 106 may use the information in the report 406 to request and receive a distance determination using the location device 104, which provides additional accuracy relative to the access point 102.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point comprising:
a memory; and
a processor communicatively coupled to the memory, the processor configured to:
provide a location determination for a client device according to a first accuracy level;
in response to receiving, from the client device, a request for a second accuracy level of location determination greater than the first accuracy level, determine a location device that provides the second accuracy level; and
communicate, to the client device, a report indicating a neighboring access point and the location device.

2. The access point of claim 1, wherein the processor is further configured to communicate, to the client device, a first key, wherein the report comprises a first portion and a second portion, wherein the first key decrypts the second portion, wherein the first portion indicates the neighboring access point, and wherein the second portion indicates the location device.

3. The access point of claim 1, wherein the processor is further configured to determine a type of the client device, wherein determining the location device is based on the type of the client device.

4. The access point of claim 1, wherein the location device comprises an ultra-wideband anchor.

5. The access point of claim 4, wherein the location device further comprises an access point connected to the ultra-wideband anchor.

6. The access point of claim 1, wherein providing the location determination according to the first accuracy level comprises performing a fine timing measurement exchange with the client device.

7. The access point of claim 1, wherein the report is an 802.11k neighbor report.

8. The access point of claim 1, wherein the report indicates an address of the neighboring access point and an address of the location device.

9. The access point of claim 1, wherein the report indicates a location of the neighboring access point and a location of the location device.

10. A method comprising:
providing, by an access point, a location determination for a client device according to a first accuracy level;
in response to receiving, from the client device, a request for a second accuracy level of location determination greater than the first accuracy level, determining a location device that provides the second accuracy level; and
communicating, to the client device, a report indicating a neighboring access point and the location device.

11. The method of claim 10, further comprising communicating, to the client device, a first key, wherein the report comprises a first portion and a second portion, wherein the first key decrypts the second portion, wherein the first portion indicates the neighboring access point, and wherein the second portion indicates the location device.

12. The method of claim 10, further comprising determining a type of the client device, wherein determining the location device is based on the type of the client device.

13. The method of claim 10, wherein the location device comprises an ultra-wideband anchor.

14. The method of claim 13, wherein the location device further comprises an access point connected to the ultra-wideband anchor.

15. The method of claim 10, wherein providing the location determination according to the first accuracy level comprises performing a fine timing measurement exchange with the client device.

16. The method of claim 10, wherein the report is an 802.11k neighbor report.

17. The method of claim 10, wherein the report indicates an address of the neighboring access point and an address of the location device.

18. The method of claim 10, wherein the report indicates a location of the neighboring access point and a location of the location device.

19. A non-transitory computer readable medium storing instructions that, when executed by a processor, cause the processor to:
perform a fine timing exchange with a client device to determine a location of the client device according to a first accuracy level;
in response to receiving, from the client device, a request for a second accuracy level greater than the first accuracy level, determine a location device that provides the second accuracy level, wherein the location device comprises a neighboring access point and an ultra-wideband anchor; and
communicate, to the client device, an 802.11k neighbor report that indicates (i) an address of the neighboring access point and (ii) an address of the location device.

20. The medium of claim 19, wherein the instructions further cause the processor to communicate, to the client device, a first key, wherein the 802.11k neighbor report comprises a first portion and a second portion, wherein the first key decrypts the second portion, wherein the first portion indicates the address of the neighboring access point, and wherein the second portion indicates the address of the location device.
